(19) United States
(12) Patent Application Publication
(10) Pub. No.: US 2021/0392243 A1
(43) Pub. Date: Dec. 16, 2021

(54) HEAD MOUNTABLE CAMERA SYSTEM

(71) Applicant: Sam Salemnia, Los Angeles, CA (US)

(72) Inventor: Sam Salemnia, Los Angeles, CA (US)

(21) Appl. No.: 16/898,010

(22) Filed: Jun. 10, 2020

(51) Int. Cl. H04N 5/225; G03B 17/04; G06F 1/16; G02B 27/01

(52) U.S. Cl. CPC H04N 5/2252; G03B 17/04; G02B 2027/0138; G02B 27/0172; G06F 1/163

(57) ABSTRACT

A head mountable camera system includes a head covering and a camera system removably attached to the head covering in an inner space. The camera system includes a band, a camera within an interior cavity of the band including a lens exposed through a first surface of the band and exposed through at least one opening in the first surface of the head covering, a controller within the interior cavity for controlling the at least one camera, a power source within the interior cavity configured to power the controller and the at least one camera, and electrical connections connecting the controller, the power source, and the at least one camera together.

### BACKGROUND

### 1. Field

Embodiments of the present invention relate to wearable cameras.

### 2. Description of the Related Art

Wearable cameras have been increasing in use recently for both athletic and non-athletic situations. Many wearable cameras are bulky and/or uncomfortable to wear.

Wearable cameras can also get in the way of or restrict movement of participants when playing sports such as basketball or doing other activities or sports that require a freedom of motion.

Additionally, many wearable cameras are clearly identifiable as such. When a wearable camera is clearly visible, it may make other participants uncomfortable or the camera may become the target of thieves.

### SUMMARY

The present disclosure is directed to various embodiments of a head mountable camera system. In one embodiment, the head mountable camera system includes a head covering comprising a first surface, a second surface, an inner space between the first surface and the second surface, and at least one opening in the first surface. The head mountable camera system also includes a camera system removably attached to the head covering in the inner space. The camera system includes a band having a first surface facing the first surface of the head covering, a second surface facing the second surface of the head covering, and an interior cavity between the first surface and the second surface of the band. The camera system also includes at least one camera within the interior cavity, the at least one camera including a lens exposed through the first surface of the band and exposed through the at least one opening in the first surface of the head covering, a controller within the interior cavity for controlling the at least one camera, a power source within the interior cavity configured to power the controller and the at least one camera, and electrical connections connecting the controller, the power source, and the at least one camera together.

The head covering may be a sports helmet, a law enforcement hat, a military helmet, a crash helmet, a sports cap, a full face mask, or a half face mask.

The head covering may include a crown and a brim coupled to the crown.

The first surface of the head covering may be an outer surface of the crown.

The first surface of the head covering may be an upper surface or a lower surface of the brim.

The at least one opening in the head covering may include a series of openings circumferentially arranged around the first surface of the head covering, and the at least one camera of the camera system may include a series of cameras circumferentially arranged around the band.

The at least one camera, the controller, the power source, and the electrical connections may be circumferentially arranged within the interior cavity of the band.

The band may be waterproof.

The band may include a washable fabric.

The band may be flexible.

The camera system may include an opening in the band through which the at least one camera, the controller, the power source, and the electrical connections can be removed.

The head mountable camera system may also include a fastener configured to close the opening in the band.

The head mountable camera system may include a substrate within the interior cavity of the band on which at least two of the at least one camera, the controller, and the power source are mounted, and the substrate may be flexible but not stretchable.

The head mountable camera system may include an elastic band in the interior cavity of the band.

The electrical connections may include a flexible ribbon cable or wires woven in a pattern configured to provide elasticity and flexibility.

The head mountable camera system may include electro-magnetic shielding between the first surface of the band and one or more of the power source, the at least one camera, and the controller.

The head mountable camera system may include a memory device in the interior cavity of the band.

The controller may include an interconnection module configured to connect to an outside device, and the interconnection module may include a charge port and a micro-USB port and/or a wireless connection module.

The wireless connection module may include a short-range wireless module, a wireless module, and/or a cellular module.

The controller may also include a logical processor, an image stabilization module, an image processor, an on/off switch, an autofocus controller, a GPS module, a gyrometer, an accelerometer, an altimeter, a pulse oximeter, and/or a pedometer.

The head mountable camera system may also include microphone.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable head mountable camera system.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a perspective view of a camera system according to an exemplary embodiment of the present invention.

FIG. 2 is a perspective view of the camera system showing components hidden from view according to the exemplary embodiment of the present invention.

FIG. 3 is a block diagram of a controller, a camera, and a power source according to another exemplary embodiment of the present invention.

FIG. 4 is a perspective view of the body mounted camera system showing components hidden from view according to still another exemplary embodiment of the present invention.

FIG. 5 is a plan view of electrical connections in a relaxed position according to an embodiment of the present invention.

FIG. 6 is a plan of the electrical connections of FIG. 5 in a stretched condition.

FIGS. 7A-7C are a front view, a side view, and a cross-sectional view, respectively, of a head mountable camera system according to one embodiment of the present disclosure including the embodiment of the camera system illustrated in FIG. 1 incorporated into a football helmet.

FIGS. 8A-8C are a perspective view, a front view, and a side view, respectively, of a head mountable camera system according to one embodiment of the present disclosure including the embodiment of the camera system illustrated in FIG. 1 incorporated into a baseball cap.

FIG. 8D is a perspective view of a head mountable camera system according to another embodiment of the present disclosure including the embodiment of the camera system illustrated in FIG. 1 incorporated into a baseball cap.

FIGS. 9A-9B are a perspective view and a cross-sectional view, respectively, of a head mountable camera system according to one embodiment of the present disclosure including the embodiment of the camera system illustrated in FIG. 1 incorporated into a law enforcement officer's peaked cap.

### DETAILED DESCRIPTION

The present disclosure relates to various embodiments of a head mountable camera system including a camera system detachably or removably coupled to headgear, headwear, a headdress, or other head covering, such as a sports helmet (e.g., a football helmet, a baseball helmet, a hockey helmet, a fencing helmet or mask, an umpire mask, or a ski helmet), a law enforcement hat (e.g., a peaked cap), a military helmet, a crash helmet (e.g., a motorcycle helmet or a bike helmet), a hat (e.g., a baseball cap or other sports cap), or a full or half face mask. The camera system according to embodiments of the present disclosure includes a band housing at least one camera, a controller, and a power supply. The camera includes a lens exposed to the outside of the band and to the outside of the head covering for recording video or still pictures. In one or more embodiments, the band may be waterproof and/or a washable fabric.

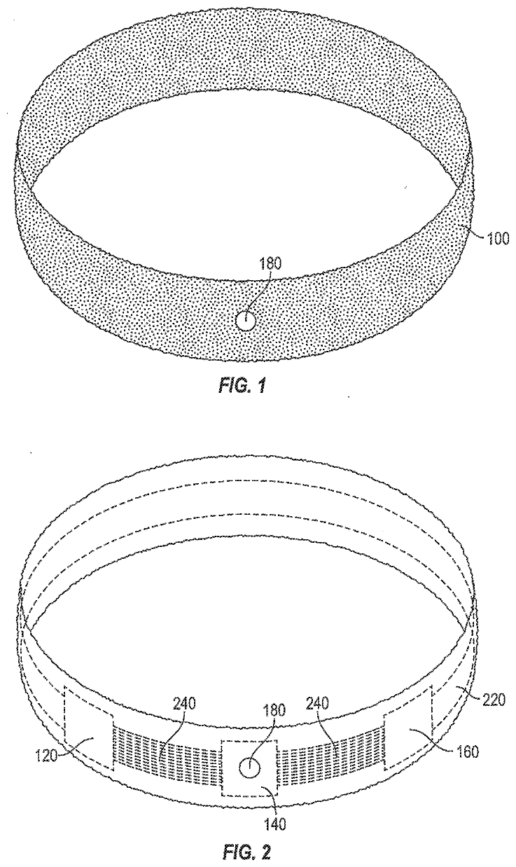

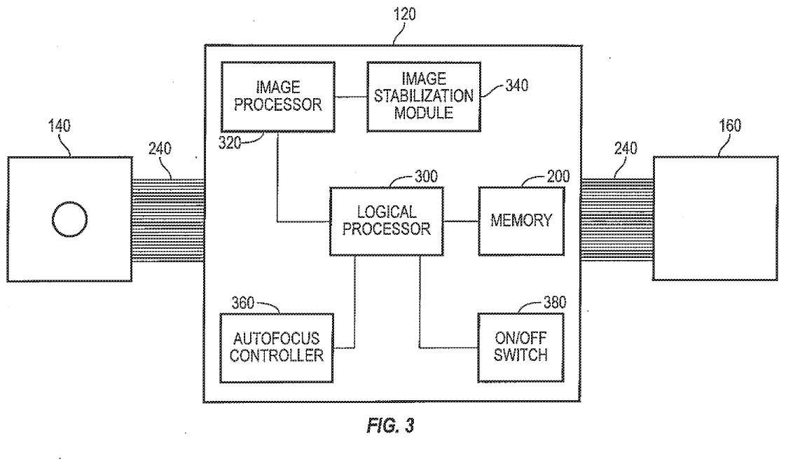

A body mounted camera system according an embodiment of the present invention will now be described with reference to FIGS. 1 and 2. FIG. 1 is a perspective view of a body mounted camera system according to the exemplary embodiment of the present invention and FIG. 2 is a perspective view of the body mounted camera system showing components hidden from view (in broken lines) according to the exemplary embodiment of the present invention.

Referring to FIGS. 1 and 2, a camera system according to an embodiment of the present invention includes a band structure 100, a controller 120, a camera 140, and a power source 160. The camera 140 includes a lens 180 exposed to the outside of the band structure 100.

The band structure 100 includes an inner surface, an outer surface, and an inner cavity between the inner surface and the outer surface. The inner cavity of the band structure 100 houses the controller 120, the camera 140, and the power source 160. Further, the inner cavity of the band structure 100 may be annular in shape. The outer surface of the band structure 100 has a portion through which the lens 180 is exposed. The portion of the outer surface may be an opening or be made of an optically transparent (i.e., optically clear) material.

The band structure 100 may be made of any suitable material for making headbands or armbands. In some embodiments the band structure 100 is made of fabric or cloth and the fabric or cloth may be elastic. In one or more embodiments, the band structure 100 may be a washable fabric. In one or more embodiments, the band structure 100 may be waterproof.

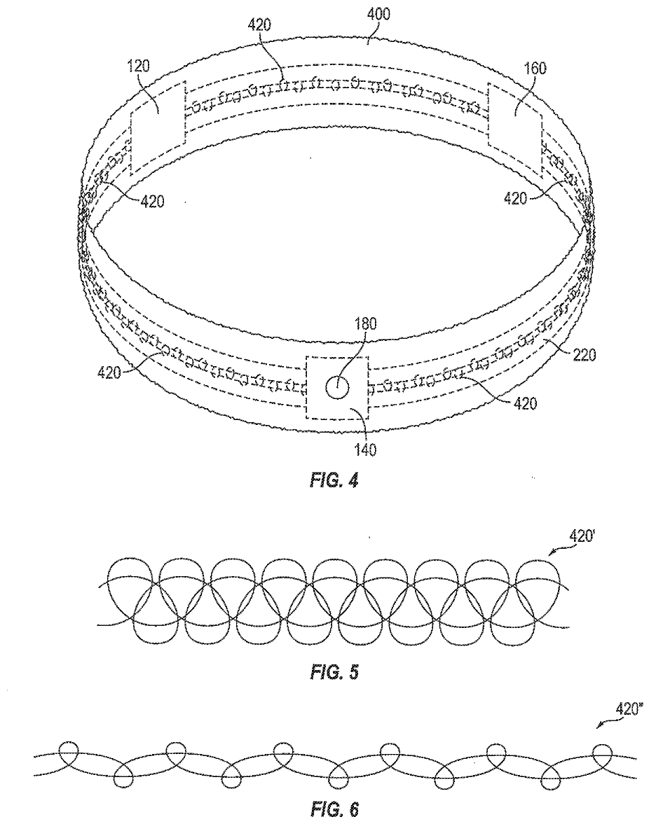

The controller 120 is capable of controlling the camera 140. The controller receives power from the power source 160. The controller 120 controls the camera 140 to record video, take pictures, and/or end the recording of video. The controller 120 receives the pictures from the camera either in still or in motion video form. The controller may store the pictures and/or videos in memory 200 (see FIG. 3 and corresponding description herein). Alternatively, the controller may stream the still pictures and/or videos directly to an external device. The streaming may occur wirelessly using a suitable wireless technology. Suitable wireless technologies may include Bluetooth®, Wi-Fi®, or cellular (e.g., 2G, 3G, 4G, or 5G) technologies.

The controller 120 may include a charge port when the power source 160 is rechargeable. Further, the controller 120 may include an interconnection module. The interconnection module facilitates connection with the external device. The interconnection module may be any of various types of suitable interconnection modules, for example, a micro-USB port, a Bluetooth® module, a Wi-Fi®, module, or a cellular module. When the interconnection module is a micro-USB module, a separate charge port would not necessarily be provided.

The camera 140 may be any one of various types of cameras that provide a thin form factor, light weight, low power consumption, and capability of recording motion videos and/or taking still pictures. The camera 140 receives power from the power source 160.

The camera 140 includes the lens 180. The lens 180 is exposed to the outside through the portion of the outer surface of the band structure 100. In the embodiment where the portion of the outside surface is an opening, the lens 180 extends into the opening and the lens may be flush with the outer surface or may protrude from the outer surface. In the embodiment where the portion of the outside surface is an optically clear material, the lens is positioned to capture images and/or videos through the optically clear material. In some embodiments, the lens 180 and the band structure 100 are constructed so that the presence of the lens 180 is not easily seen by outside observers.

The camera 140 may include a microphone. Alternatively, a microphone (if included) may be part of the controller 120.

The body mounted camera system may include a plurality of cameras 140. The body mounted camera system may include two cameras 140 spaced apart from each other for creating three dimensional (3D) pictures or videos. The body mounted camera system may include multiple cameras 140 for creating pictures or videos from multiple angles and perspectives and/or virtual reality (360° pictures or videos). The controller 120 may be capable of merging pictures or video frames from the multiple camera into a single wide-angle, 3D, or 360° picture or video frame.

The power supply 160 may be any of various types of portable power supplies. For example, the power supply 160 may be a battery, a portable fuel cell, etc.

The body mounted camera system may include a substrate or support onto which the controller 120, the camera 140, the power source 160, or a combination thereof are mounted. The substrate may be any suitable material for mounting the controller 120, the camera 140, the power source 160, or a combination thereof which provides flexibility while preventing stretching. For example the substrate may be made of cloth or plastic. The substrate may be made of the same material as the band structure 100 but be processed differently to reduced stretchability.

The body mounted camera system may include electro-magnetic shielding between the inner surface of the band structure 100 and one or more of the controller 120, the camera 140, and the power source 160. The shielding may prevent electric or magnetic fields from extending into the user (i.e., reaching the user). In some embodiments, the shielding is provided within the substrate.

The band structure 100 may include an opening for removing one or more of the controller 120, the camera 140, and the power source 160. The controller 120, the camera 140, and the power source 160 may be removed from the band structure 100 to permit washing of the band structure 100. By removing the controller 120, the camera 140, and the power source 160, the band structure 100 can be cleaned without damaging those components. When the controller 120, the camera 140, and the power source 160 are within the band structure 100, the opening may be closed using any of various suitable fastening structures (e.g., using a hook and loop or other attachment structure).

The body mounted camera system may or may not include an elastic band 220. When the body mounted camera system includes the elastic band 220, the elastic band 220 provides elasticity to the band structure 100. The elastic band 220 allows the body mounted camera system to be held in place in various locations of the users body. For example, the elastic band 220 may allow the band structure 100 to operate as a headband or armband.

When the body mounted camera system does not include the elastic band 220, the body mounted camera system may include other methods of fastening the band structure 100 to a user's body. In one embodiment the band structure 100 has straps that use a hook and loop attachment method (e.g., Velcro®) and can be attached to a user's head, arm, and/or other suitable body part by means of the hook and loop attachment method.

The controller 120, the camera 140, and the power source 160 are electrically connected via electrical connections 240. Electrical connections 240 provide electrical pathways for communication signals between the controller 120, the camera 140, and the power source 160. Electrical connections 240 may be a type of ribbon cable but the present invention is not limited thereto. When the electrical connections 240 are a type of ribbon cable, electrical connections 240 have good flexibility but low stretchability.

As can be seen in FIG. 1, neither the controller 120 nor the power source 160 are visible from the outside and only the lens 180 of the camera 140 is visible from the outside.

A controller, a camera, and a power source according to an embodiment of the present invention will now be described with reference to FIG. 3. FIG. 3 is a block diagram of a controller, a camera, and a power source according to the embodiment of the present invention.

Referring to FIG. 3, the camera 140 is connected to the controller 120 via electrical connections 240 and the controller 120 is connected to the power source 160 via electrical connections 240.

The controller 120 is capable of controlling the camera 140. The controller receives power from the power source 160. The controller 120 controls the camera 140 to record video, take pictures, and/or end recording of video. The controller 120 receives the pictures or videos from the camera. The controller stores the pictures and/or videos in memory 200.

The controller 120 according to the present embodiment includes the memory 200, a logical processor 300, an image processor 320, an image stabilization module 340, an autofocus controller 360, and an On/Off switch 380, but the present invention is not limited thereto. Embodiments of the present invention may include any combination of these components, including all or none of them.

The memory 200 may be an internal memory such as a flash memory or a solid state memory or may be a memory slot for inserting and removing a removable memory. The logical processor 300 may provide intercommunication between and control of the memory 200, the image processor 320, and the autofocus controller 360.

The image processor 320 may receive the picture or video frames from the camera 140 directly or may receive the picture or video frames from the logical processor 300 which receives the picture or video frames from the camera 140. The image processor 320 may process the picture or video frames and may compile the video frames into a single video.

The image processor 320 utilizes the image stabilization module 340 to stabilize (e.g., correct for motion blur, etc.) a video that was recording while the body mounted camera system was in motion.

Prior to sending the command to take a picture or video, or while taking a video, the logical processor 300 may issue a command to the autofocus controller 360 to focus the camera 140. When the autofocus controller 360 receives the command, the autofocus controller 360 controls the camera to automatically focus the camera.

The logical processor may control the camera 140, the power supply 160, the memory 200, the image processor 320, and the autofocus controller 360 to turn on or turn off according to input from the On/Off switch 380.

The controller 120 may further include one or more of a GPS module, a gyrometer, an accelerometer, an altimeter, a pulse oximeter, and a pedometer.

The controller and/or any other relevant devices or components according to embodiments of the present invention described herein may be implemented utilizing any suitable hardware, firmware (e.g. an application-specific integrated circuit), software, or a suitable combination of software, firmware, and hardware. The various components of the controller may be formed as one integrated device or as multiple separate devices. For example, the various components of the controller may be formed on one integrated circuit (IC) chip or on separate IC chips. Further, the various components of the controller may be implemented on a flexible printed circuit film, a tape carrier package (TCP), a printed circuit board (PCB), or formed on a same substrate as one or more circuits and/or devices of the body mounted camera system. Further, the various components of the controller may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

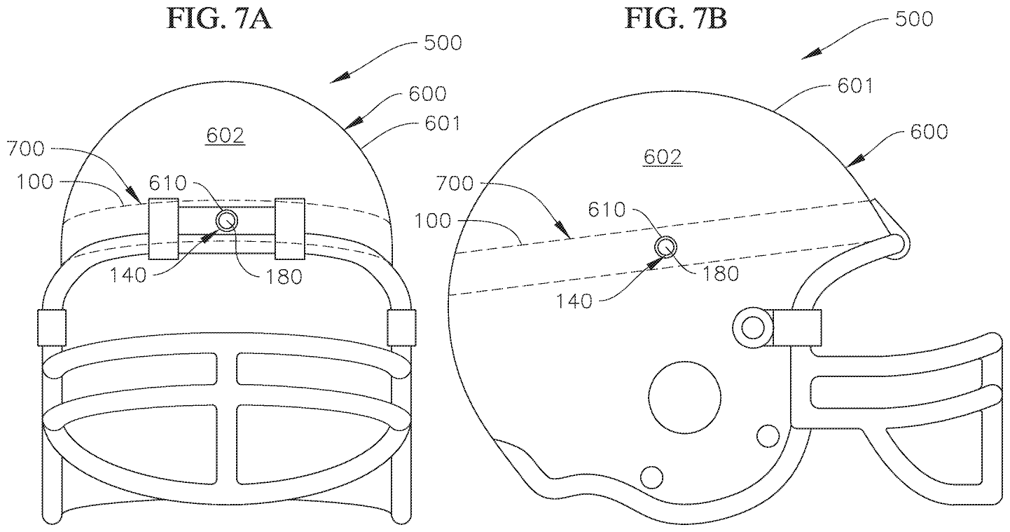

A body mounted camera system according an embodiment of the present invention will now be described with reference to FIG. 4. FIG. 4 is a perspective view of the body mounted camera system showing components hidden from view according to the embodiment of the present invention. Some components of the body mounted camera system of FIG. 4 may be the same as components of the body mounted camera system of FIGS. 1-3 and, as such, duplicate descriptions of the same or similar elements or components thereof may be omitted.

Referring to FIG. 4, the body mounted camera system, according to the embodiment of the present invention, includes a band structure 400, a controller 120, a camera 140, and a power source 160. The camera 140 includes a lens 180 exposed to the outside of the band structure 400.

In this embodiment, the controller 120, the camera 140, and the power source 160 are spaced from each other. The spacing of the controller 120, the camera 140, and the power source 160 may provide better weight distribution and may make it easier for a user to wear the body mounted camera system.

When the body mounted camera system includes components that a spaced throughout the band structure 400 and the body mounted camera system includes an elastic band 220 the distance between the components may vary depending on the degree of stretching applied to the elastic band 220. In this case, electrical connections between the components may be damaged by the change in distance between the components.

According to the present embodiment, electrical connections 420 have high elasticity and flexibility. Any suitable method of providing electrical connections 420 with high elasticity and flexibility may be used.

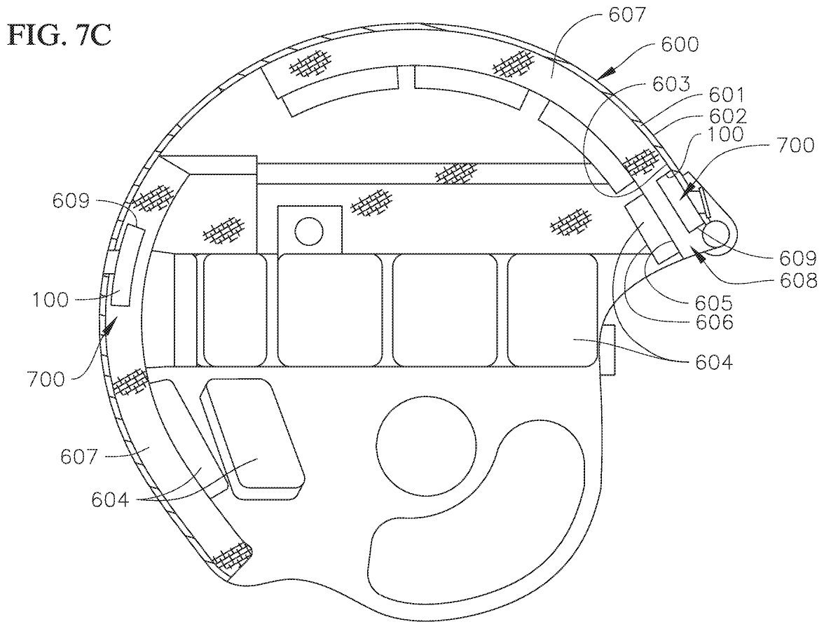

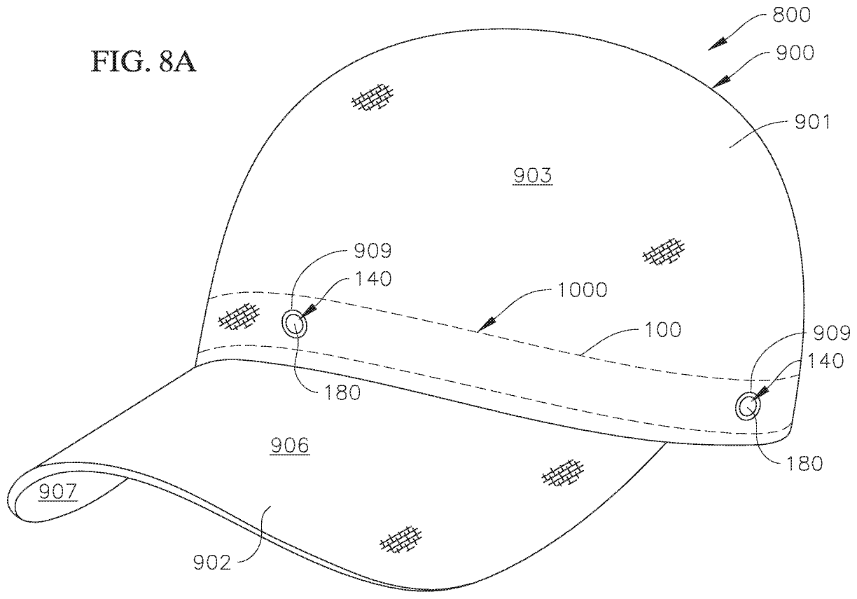

FIGS. 5 and 6 are plan views of electrical connections having high elasticity and flexibility according to an embodiment of the present invention.

As can be seen in FIGS. 5 and 6, electrical connections 420 include wires 420′ (e.g., wires with a metal core and plastic insulation coating) woven in a pattern. The pattern is chosen such that when a force is applied to stretch the electrical connections 420, the wires 420′ are not broken. Rather they are bent or otherwise elastically deformed to create a suitable restoring force in the structure of the electrical connections 420.

FIG. 5 shows an exemplary pattern of wires 420′ in a non-stretched position. FIG. 6 shows the wires 420″ in the exemplary pattern in a stretched position. As can be seen in FIG. 6, the wires 420″ have smaller loops than the wires 420′ and the loops in the wires 420″ are spaced farther apart that the loops in the wires 420′.

When the force is no longer being applied to the electrical connections 420, the loops in the wires 420″ relax back to the size of the loops in the wires 420′, and because of this, the loops are brought closer together.

The camera system described above with reference to the embodiments depicted in FIGS. 1-6 may be incorporated into any suitable type or kind of headgear, headwear, headdress, or head covering, such as, for example, a sports helmet (e.g., a football helmet, a baseball helmet, a hockey helmet, a fencing helmet or mask, an umpire mask, or a ski helmet), a law enforcement hat (e.g., a peaked cap), a military helmet, a crash helmet (e.g., a motorcycle helmet or a bike helmet), a hat (e.g., a baseball cap or other sports cap), or a full or half face mask. The one or more cameras of the camera system are exposed to an exterior of the headgear, headwear, headdress, or head covering such that the camera is configured to record video and/or still images of the environment around the user wearing the headgear, headwear, headdress, or head covering.

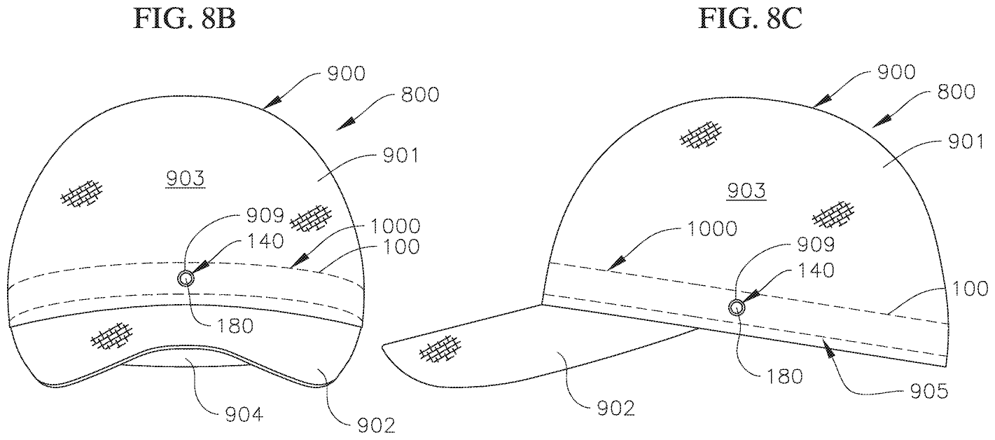

FIGS. 7A-7C depict a head mountable camera system 500 according to one embodiment of the present disclosure including a football helmet 600 and a camera system 700 removably or detachably coupled to the football helmet 600. In one or more embodiments, the camera system 700 may be the same as or similar to an embodiment of the camera system described above with reference to FIGS. 1-6. Although in one or more embodiments the camera system 700 may include each of the components of the camera system described above with reference to FIGS. 1-6, in one or more embodiments, the camera system 700 may include fewer than all of the components described above with reference to FIGS. 1-6. In the illustrated embodiment, the football helmet 600 includes an outer protective shell 601 having an outer surface 602 and an inner surface 603, inner protective padding 604 having an outer surface 605 and an inner surface 606, and padding 607 in an inner space 608 between the outer protective shell 601 and the inner protective padding 604.

Additionally, in the illustrated embodiment, the camera system 700 is removably or detachably housed in the inner space 608 of the football helmet 600 between the outer protective shell 601 and the inner protective padding 603. For instance, in one or more embodiments, the camera system 700 may be removably or detachably housed in an opening 609 (e.g., a slot) in the padding 607 in the inner space 608.

Additionally, in the illustrated embodiment, the outer protective shell 601 includes at least one opening 610 configured to align with the at least one camera 140 of the camera system. Each of the openings 610 extend from the inner surface 603 to the outer surface 602 of the outer protective shell 601 such that the openings 610 are in communication with the inner space 608. The outer protective shell 601 may have any other suitable number of openings 610 and the openings 610 may be arranged in any other suitable arrangement depending on the number and arrangement of the cameras 140 of the camera system. For instance, in one or more embodiments in which the camera system 700 includes a series of cameras 140 circumferentially arranged around the band structure 100, the football helmet 600 may include a series of openings 610 circumferentially arranged around the outer protective shell 601 that are aligned with the cameras 140 and the lenses 180 of the cameras 140 such that the cameras 140 and the lenses 180 are exposed on the outer surface 602 of the outer protective shell 601 of the football helmet 600. Additionally, although in the illustrated embodiment the band structure 100 of the camera system 700 is oriented horizontally or substantially horizontally, in one or more embodiments, the band structure 100 of the camera system 700 may be oriented with any other suitable orientation inside the football helmet 700.

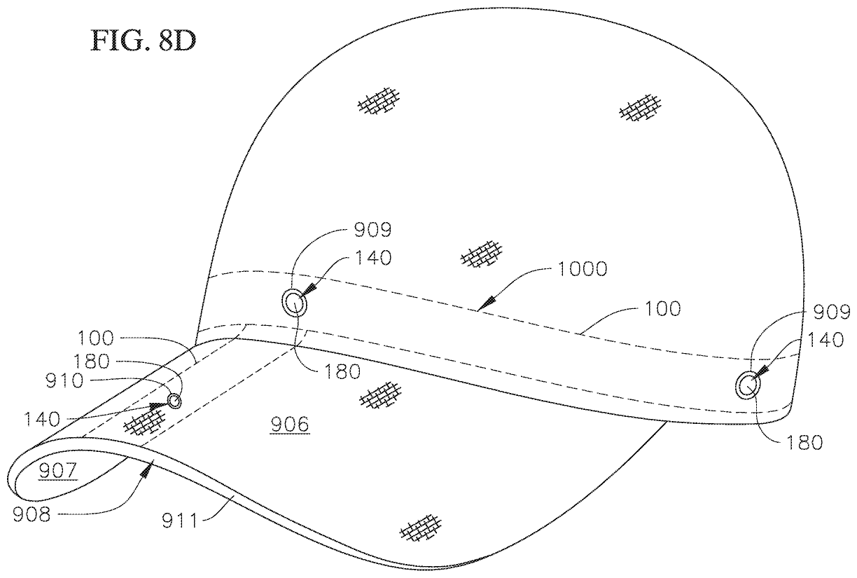

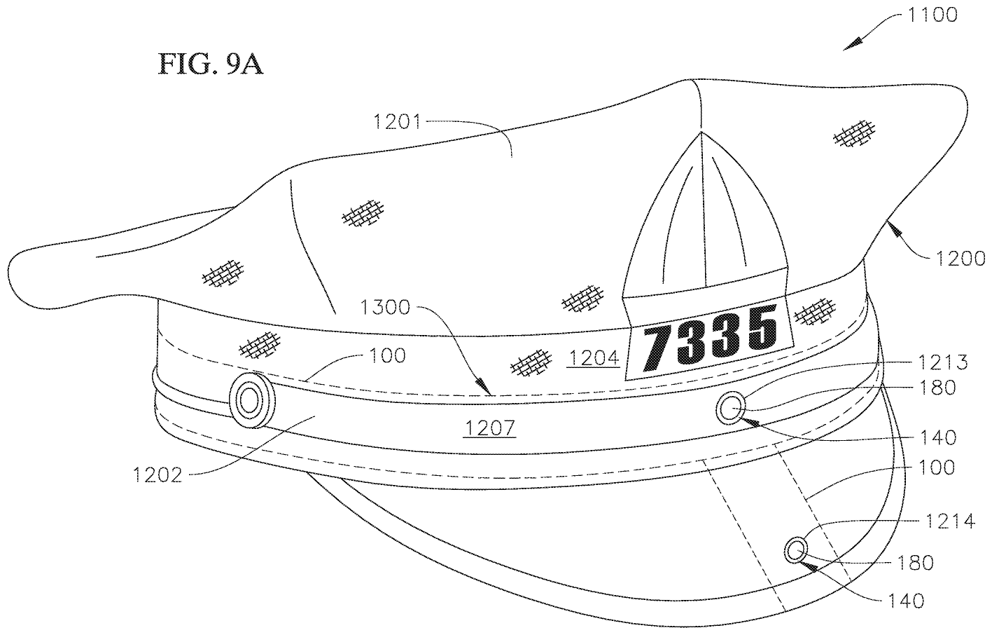

FIGS. 8A-8C depict a head mountable camera system 800 according to one embodiment of the present disclosure including a baseball cap 900 and a camera system 1000 removably or detachably coupled to the baseball cap 900. In one or more embodiments, the camera system 1000 may be the same as or similar to an embodiment of the camera system described above with reference to FIGS. 1-6. Although in one or more embodiments the camera system 1000 may include each of the components of the camera system described above with reference to FIGS. 1-6, in one or more embodiments, the camera system 1000 may include fewer than all of the components described above with reference to FIGS. 1-6. In the illustrated embodiment, the baseball cap 900 includes a crown 901 and a brim 902 (i.e., a bill or a visor) attached to the crown 901. In the illustrated embodiment, the crown 901 includes an outer surface 903, an inner surface 904, and an inner space 905 between the outer surface 903 and the inner surface 904. Additionally, in the illustrated embodiment, the brim 902 of the baseball cap 900 includes an upper surface 906, a lower surface 907, and an inner space 908 between the upper surface 906 and the lower surface 907.

Additionally, in the illustrated embodiment, the camera system 1000 is removably or detachably housed in the inner space 905 of the crown 901 of the baseball cap 900 between the outer surface 903 and the inner surface 904. Additionally, in the illustrated embodiment, the outer surface 903 of the crown 901 of the baseball cap 900 includes at least one opening 909 configured to align with the at least one camera 140 of the camera system 1000. Each of the openings 909 are in communication with the inner space 905 of the crown 901 in which the camera system 1000 is removably or detachably housed. The outer surface 903 of the crown 901 may have any other suitable number of openings 909 and the openings 909 may be arranged in any suitable arrangement depending on the desired number and arrangement of the cameras 140 of the camera system 1000 that are exposed on the crown 901 of the baseball cap 900. For instance, in one or more embodiments in which the camera system 1000 includes a series of cameras 140 circumferentially arranged around the band structure 100, the baseball cap 900 may include a series of openings 908 circumferentially arranged around the crown 901 that are aligned with the cameras 140 and the lenses 180 of the cameras 140 such that the cameras 140 and the lenses 180 are exposed on the outer surface 903 of the crown 901 of the baseball cap 900. Additionally, although in the illustrated embodiment the band structure 100 of the camera system 1000 is oriented horizontally or substantially horizontally in the crown 901 of the baseball cap 900, in one or more embodiments, the band structure 100 of the camera system 1000 may be oriented with any other suitable orientation inside the crown 901 of the baseball cap 900.

In one or more embodiments, at least a portion of the camera system 1000 may be removably or detachably housed in the inner space 908 of the brim 902 of the baseball cap 900 between the upper surface 906 and the lower surface 907. Additionally, in one or more embodiments, the brim 902 of the baseball cap 900 includes at least one opening 910 configured to align with at least one camera 140 of the camera system 1000 such that at least one camera 140 and at least one corresponding lens 180 of the camera system 1000 are exposed on an outer surface (e.g., the upper surface 906, the lower surface 907, and/or a front surface 911) of the brim 902. Each of the openings 910 in the brim 902 are in communication with the inner space 908 in which at least a portion of the camera system 1000 is removably or detachably housed. The one or more openings 910 in the brim 902 may be provided in the upper surface 906, the lower surface 907, and/or the front surface 907 of the brim 902 such that at least one camera 140 and at least one lens 180 are exposed on the upper surface 906, the lower surface 907, and/or the front surface 907 of the brim 902. The upper surface 906, the lower surface 907, and/or the front surface 907 of the brim 902 may have any suitable number of openings 910 and the openings 910 may be arranged in any suitable arrangement depending on the desired number and arrangement of the cameras 140 of the camera system 1000 that are exposed on the brim 902. The one or more openings 910 in the brim 909 of the baseball cap 900 may be in lieu of or in addition to the one or more openings 909 in the crown 901 of the baseball cap 900. For instance, in the embodiment illustrated in FIG. 8D, the upper surface 906 of the brim 902 includes one opening 910 exposing one lens 180 and one camera 140 of the camera system 1000 on the upper surface 906 of the brim 902, and the outer surface 903 of the crown 901 includes a series of openings 909 circumferentially arranged around the crown 901 exposing a series of lenses 180 and a series of cameras 140 of the camera system 1000 on the outer surface 903 of the crown 901.

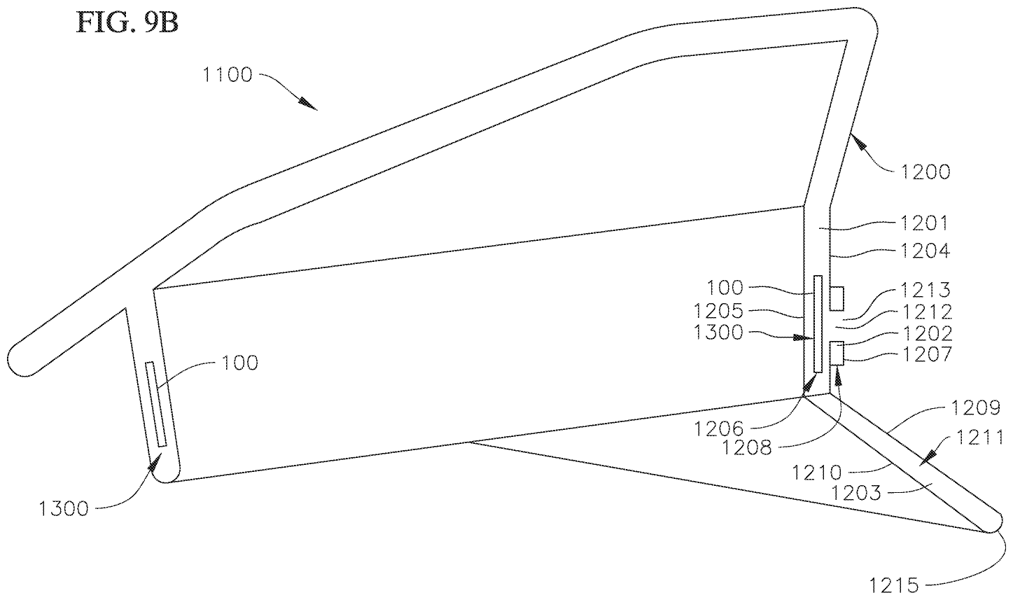

FIGS. 9A-9B depict a head mountable camera system 1100 according to one embodiment of the present disclosure including a law enforcement officer's hat 1200 (i.e., a peaked cap) and a camera system 1300 removably or detachably coupled to the law enforcement officer's hat 1200. In one or more embodiments, the camera system 1300 may be the same as or similar to an embodiment of the camera system described above with reference to FIGS. 1-6. Although in one or more embodiments the camera system 1300 may include each of the components of the camera system described above with reference to FIGS. 1-6, in one or more embodiments, the camera system 1300 may include fewer than all of the components described above with reference to FIGS. 1-6. In the illustrated embodiment, the law enforcement officer's hat 1200 includes a crown 1201, a band 1202 extending around at least a portion of the crown 1201, and a brim 1203 (i.e., a bill or a visor) attached to the crown 1201. In the illustrated embodiment, the crown 1201 includes an outer surface 1204, an inner surface 1205, and an inner space 1206 between the outer surface 1204 and the inner surface 1205. In the illustrated embodiment, the law enforcement officer's hat 1200 also includes an outer surface 1207 of the band 1202 and an inner space 1208 between the outer surface 1207 of the band 1202 and an outer surface 1204 of the crown 1204. Additionally, in the illustrated embodiment, the brim 1203 of the law enforcement officer's hat 1200 includes an upper surface 1209, a lower surface 1210, and an inner space 1211 between the upper surface 1209 and the lower surface 1210.

Additionally, in the illustrated embodiment, the camera system 1300 is removably or detachably housed in the inner space 1206 of the law enforcement officer's hat 1200 between the outer surface 1204 of the crown 1201 and an inner surface 1205 of the crown 1201. Additionally, in the illustrated embodiment, the outer surface 1204 of the crown 1201 and the outer surface 1207 of the band 1202 of the law enforcement officer's hat 1200 include at least one pair of aligned openings 1212, 1213, respectively, configured to align with the at least one camera 140 of the camera system 1300. Each of the at least one pair of aligned openings 1212, 1213 is in communication with the inner space 1206 of the law enforcement officer's hat 1200 between the outer surface 1207 of the crown 1201 and the inner surface 1205 of the crown 1201 in which the camera system 1300 is removably or detachably housed. The outer surface 1205 of the crown 1201 and the outer surface 1207 of the band 1202 may have any other suitable number of openings 1212, 1213 and the openings 1212, 1213 may be arranged in any suitable arrangement depending on the desired number and arrangement of the cameras 140 of the camera system 1300 that are exposed on the outer surface 1207 of the band 1202 of the law enforcement officer's hat 1200. For instance, in one or more embodiments in which the camera system 1300 includes a series of cameras 140 circumferentially arranged around the band structure 100, the law enforcement officer's hat 1200 may include a series of openings 1212 circumferentially arranged around the band 1202 that are aligned with the cameras 140 and the lenses 180 of the cameras 140 such that the cameras 140 and the lenses 180 are exposed on the outer surface 1207 of the band 1202 of the law enforcement officer's hat 1200. Additionally, although in the illustrated embodiment the band 100 of the camera system 1300 is oriented horizontally or substantially horizontally in the band 1202 of the law enforcement officer's hat 1200, in one or more embodiments, the band 100 of the camera system 1300 may be oriented with any other suitable orientation inside the band 1202 of the law enforcement officer's hat 1200. In one or more embodiments in which the camera system 1300 is housed in the inner space 1206 of the law enforcement officer's hat 1200 between the outer surface 1207 of the crown 1201 and the inner surface 1205 of the crown 1201, the camera system 1300 may not be aligned with (e.g., covered by) the band 1202. Accordingly, in one or more embodiments, the law enforcement officer's hat 1200 may not be provided with one or more openings 1213 in the band 1202 (the law enforcement officer's hat 1200 may be provided only with the one or more openings 1212 in the outer surface 1204 of the crown 1201) such that the one or more cameras 140 and the lenses 180 of the camera system 1300 are exposed on the outer surface 1204 of the crown 1201 of the law enforcement officer's hat 1200.

In one or more embodiments, the camera system 1300 (or at least a portion thereof) may be housed in the inner space 1208 between the outer surface 1207 of the band 1202 and the outer surface 1204 of the crown 1201. Additionally, in one or more embodiments in which the camera system 1300 (or at least a portion thereof) is housed in the inner space 1208 between the outer surface 1207 of the band 1202 and the outer surface 1204 of the crown 1201, the openings 1212 may not be provided in the outer surface 1204 of the crown 1201 (e.g., the one or more openings 1213 may be provided only in the outer surface 1207 of the band 1202).

In one or more embodiments, at least a portion of the camera system 1300 may be removably or detachably housed in the inner space 1211 of the brim 1203 of the law enforcement officer's hat 1200 between the upper surface 1209 and the lower surface 1210. Additionally, in one or more embodiments, the brim 1203 of the law enforcement officer's hat 1200 may include at least one opening 1214 configured to align with at least one camera 140 of the camera system 1300 such that at least one camera 140 and the at least one corresponding lens 180 of the camera system 1300 are exposed on an outer surface (e.g., the upper surface 1209, the lower surface 1210, and/or a front surface 1215) of the brim 1203. Each of the at least one opening 1214 in the brim 1203 is in communication with the inner space 1211 in which at least a portion of the camera system 1300 is removably or detachably housed. The one or more openings 1214 in the brim 1203 may be provided in the upper surface 1209, the lower surface 1210, and/or the front surface 1215 of the brim 1203 such that at least one camera 140 and at least one lens 180 are exposed on the upper surface 1209, the lower surface 1210, and/or the front surface 1215 of the brim 1203. The upper surface 1209, the lower surface 1210, and/or the front surface 1215 of the brim 1203 may have any suitable number of openings 1214 and the openings 1214 may be arranged in any suitable arrangement depending on the desired number and arrangement of the cameras 140 of the camera system 1300 that are exposed on the brim 1203. The one or more openings 1214 in the brim 1203 of the law enforcement officer's hat 1200 may be in lieu of or in addition to the one or more openings 1212 in the crown 1201 and/or the one or more openings 1213 in the band 1202 of the law enforcement officer's hat 1200.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “one or more of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

Although this invention has been described in certain specific embodiments, those skilled in the art will have no difficulty devising variations to the described embodiment, which in no way depart from the scope and spirit of the present invention. Furthermore, to those skilled in the various arts, the invention itself herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents.

What is claimed is:

1. A head mountable camera system comprising:
a head covering comprising a first surface, a second surface, an inner space between the first surface and the second surface, and at least one opening in the first surface; and
a camera system removably attached to the head covering in the inner space, the camera system comprising:
a band comprising a first surface facing the first surface of the head covering, a second surface facing the second surface of the head covering, and an interior cavity between the first surface and the second surface of the band;
at least one camera within the interior cavity, the at least one camera comprising a lens exposed through the first surface of the band and exposed through the at least one opening in the first surface of the head covering;
a controller within the interior cavity for controlling the at least one camera;
a power source within the interior cavity configured to power the controller and the at least one camera; and
electrical connections connecting the controller, the power source, and the at least one camera together.

2. The head mountable camera system of claim 1, wherein the head covering is selected from the group consisting of a sports helmet, a law enforcement hat, a military helmet, a crash helmet, a sports cap, a full face mask, and a half face mask.

3. The head mountable camera system of claim 1, wherein the head covering comprises a crown and a brim coupled to the crown.

4. The head mountable camera system of claim 3, wherein the first surface of the head covering is an outer surface of the crown.

5. The head mountable camera system of claim 3, wherein the first surface of the head covering is an upper surface or a lower surface of the brim.

6. The head mountable camera system of claim 1, wherein the at least one opening in the head covering comprises a plurality of openings circumferentially arranged around the first surface of the head covering, and wherein the at least one camera of the camera system comprises a plurality of cameras circumferentially arranged around the band.

7. The head mountable camera system of claim 1, wherein the at least one camera, the controller, the power source, and the electrical connections are circumferentially arranged within the interior cavity of the band.

8. The head mountable camera system of claim 1, wherein the band is waterproof.

9. The head mountable camera system of claim 1, wherein the band comprises a washable fabric.

10. The head mountable camera system of claim 1, wherein the band is flexible.

11. The head mountable camera system of claim 1, wherein the camera system comprises an opening in the band through which the at least one camera, the controller, the power source, and the electrical connections can be removed.

12. The head mountable camera system of claim 11, further comprising a fastener configured to close the opening in the band.

13. The head mountable camera system of claim 1, further comprising a substrate within the interior cavity of the band on which at least two of the at least one camera, the controller, and the power source are mounted, and wherein the substrate is flexible but not stretchable.

14. The head mountable camera system of claim 1, further comprising an elastic band in the interior cavity of the band.

15. The head mountable camera system of claim 1, wherein the electrical connections comprise a flexible ribbon cable or wires woven in a pattern configured to provide elasticity and flexibility.

16. The head mountable camera system of claim 1, further comprising electro-magnetic shielding between the first surface of the band and one or more of the power source, the at least one camera, and the controller.

17. The head mountable camera system of claim 1, further comprising a memory device in the interior cavity of the band.

18. The head mountable camera system of claim 1, wherein the controller comprises an interconnection module configured to connect to an outside device, and wherein the interconnection module comprises a charge port and at least one of a micro-USB port or a wireless connection module.

19. The head mountable camera system of claim 18, wherein the wireless connection module comprises one or more of:
a short-range wireless module;
a wireless module; or
a cellular module.

20. The head mountable camera system of claim 1, wherein the controller further comprises one or more of:
a logical processor;
an image stabilization module;
an image processor;
an on/off switch;
an autofocus controller;
a GPS module;
a gyrometer;
an accelerometer;
an altimeter;
a pulse oximeter; or
a pedometer.

21. The head mountable camera system of claim 1, further comprises a microphone.
